(19) United States
(12) Patent Application Publication
(10) Pub. No.: US 2001/0036290 A1
(43) Pub. Date: Nov. 1, 2001

(54) Lobe control for an acoustic horn

(76) Inventor: Rogelio Delgado JR., Rosston, AR (US)

Correspondence Address: Daniel L. Boots, Esq., BINGHAM SUMMERS WELSH & SPILMAN LLP, 2700 Market Tower, 10 West Market Street, Indianapolis, IN, 46204-2982, US

(21) Appl. No.: 09/843,437

(22) Filed: Apr. 26, 2001

Related U.S. Application Data
(60) Provisional application No. 60/200,197, filed on Apr. 28, 2000.

(51) Int. Cl. H04R 1/02; H04R 1/20

(52) U.S. Cl. 381/340; 381/345

(57) ABSTRACT

In accordance with the present invention, sound absorbing material is placed in close proximity to an acoustic horn to assist the horn in more effectively and distinctly placing the optimal SPL or major lobe in a desired location, thereby providing an improved sound field. In a first preferred embodiment, the sound absorbing material is arranged at the mouth just after or behind the horn. In a second preferred embodiment, the sound absorbing material is arranged at the driver end of the horn. Finally, in a third preferred embodiment of this invention, the sound absorbing material is disposed between the throat and the mount of the horn. Such an arrangement shapes the polar pattern to more closely resemble an acoustic wedge allowing improved placement of sound energy and for multiple acoustic sources to be arrayed together, thereby minimizing interference between or among the sources. When used in conjunction with multiple acoustic sources, this invention enables the acoustic sources to more closely resemble or act as one by minimizing interference. This arrangement also allows the user to more accurately and precisely predict how and where the optional SPL or major lobe will be delivered. As a practical benefit, this results in improved acoustically designed venues, i.e., movie theaters, auditoriums, gymnasiums, arenas, stadiums (indoor and outdoor) and the like, having better sound quality and consistency for the audience.

### RELATED APPLICATION

This application is a continuation-in-part of and claims priority on, U.S. provisional patent application Ser. No. 60/200,197, filed Apr. 12, 2000.

### TECHNICAL FIELD

This invention relates to loudspeakers and, more particularly, to high-performance loudspeakers and acoustic horns that allows placement of sound energy with precision, as well as allowing independent acoustic sources to resemble a single acoustic source when configured in an array.

### BACKGROUND ART

Conventional attempts to improve the placement of sound energy or to make multiple acoustic sources resemble a single source, have included typical horns that are arrayed in an attempt to reduce the interference between the two or more sources by increasing the splay angle. Such attempts sometimes involve loading horn components into a trapezoidal cabinet. The “trap” cabinets are then arranged in one or multiples such that sound can be distributed over a known area. However, a problem occurs in that sound energy past the −6 dB downpoints is typically sufficient to distribute acoustic energy in unwanted areas. When used in multiples, the overlap region between two trap cabinets has enough energy to cause ripples large enough to lead to hot and dead spots in the target area. The unfortunate result is that the sound pressure level (SPL) is not uniform in the overlap region. By relying on typical horns splayed in array, the user has no choice but to accept the interference band and accept uneven SPL across the overlap region.

Thus, a need still exists to improve the ability to control the placement of sound energy in conjunction with single or multiple acoustic sources, and to enable an operator to utilize multiple acoustic sources in an array so that minimal interference results and the resultant sound coverage pattern resembles that of a single acoustic source.

### DISCLOSURE OF INVENTION

In accordance with the present invention, sound absorbing material is placed in close proximity to an acoustic horn that assists the horn in more effectively and distinctly placing the optimal SPL or major lobe in a desired location, thereby providing an improved sound field. In a first preferred embodiment, the sound absorbing material is arranged just after or behind the horn. In a second preferred embodiment, the sound absorbing material is arranged at the driver end of the horn. Finally, in a third preferred embodiment of this invention, the sound absorbing material is disposed at the horn between the driver and its mouth.

Such an arrangement shapes the polar pattern to more closely resemble an acoustic wedge allowing improved placement of sound energy and for multiple acoustic sources to be arrayed together, thereby minimizing interference between or among the sources. This has the advantage over the prior art in that it allows the operator or sound designer to more precisely place sound energy in desired locations.

When used in conjunction with multiple acoustic sources, this invention enables the acoustic sources to more closely resemble or act as one by minimizing interference, as it is well known that an ideal sound field is created by a single acoustic source. This arrangement also allows the user to more accurately and precisely predict how and where the optional SPL or major lobe will be delivered. As a practical benefit, this results in improved acoustically designed venues, i.e., movie theaters, auditoriums, gymnasiums, arenas, stadiums (indoor and outdoor) and the like, having better sound quality and consistency for the listening audience.

The present invention may further comprise a loudspeaker enclosure having at least one opening for mounting an acoustic horn therein, a plurality of walls that define, together with a baffle board, a speaker enclosure. Within the enclosure, sound-absorbing material is placed in close proximity with the horn to more distinctly shape the polar pattern as desired.

Other objects, advantages and novel features of the invention will become apparent from the following detailed description of the invention when considered in conjunction with the accompanying drawings.

### BRIEF DESCRIPTION OF DRAWINGS

The foregoing and other features of the invention will be more particularly described in connection with the preferred embodiment and with reference to the accompanying drawings wherein:

FIG. 1 is a graphical depiction of the coverage pattern of a conventional horn having a mouth area of 256 sq. in.;

FIG. 2 is an isolated cross section of an acoustic horn assembly provided by a first preferred embodiment of the invention including sound absorbing material arranged after or behind the horn component;

FIG. 3 is an isolated cross section of an alternative preferred embodiment of an acoustic horn assembly provided by the present invention;

FIG. 4 is a graphical depiction of the coverage pattern of an acoustic horn assembly provided by this invention having a mouth area of 256 sq. in;

FIG. 5 is a polar plot of a horn assembly of this invention at certain frequencies illustrating the frequency at which the sound-absorbing material begins to absorb the sound energy;

FIG. 6 is an isolated partial cross section of an acoustic horn assembly provided by a second preferred embodiment of the invention including sound-absorbing material arranged adjacent the driver of the horn component;

FIG. 7 is an isolated partial cross section of an acoustic horn assembly provided by a third preferred embodiment of the invention including sound-absorbing material arranged adjacent the horn component at a point between the driver and the mouth of the horn; and

FIG. 8 is a perspective view of a possible loudspeaker enclosure for housing one or more of the horn assemblies provided by this invention.

### BEST MODE FOR CARRYING OUT THE INVENTION

Horns are excellent acoustic transformers if properly designed, as well as providing good sound coverage. Horns provide improved, predictable coverage patterns, and give the user or sound designer useful information on how to direct the horn so that acoustic energy is placed in the desired area(s) and minimal sound energy is directed to unwanted areas, which may cause distortion, reverberation or unintelligible sound. As is well known in the art, acoustic coverage patterns are determined by finding the point where the acoustic energy has diminished by 6 dB referenced to the on axis SPL. Unfortunately, what happens after that −6 dB downpoint does not account for energy past that point. Thus, the coverage pattern of the horn at the −9 and −12 dB downpoints is also important.

In a perfect setting, an acoustic horn would emit a perfect sound pattern in the form of a “wedge,” and the acoustic energy of the horn would not excite unwanted areas and, if arrayed, would not cause any rippling between separate horns. Thus, if one's desired model were the sound wedge, then the acoustic horn would have to begin to approach that model.

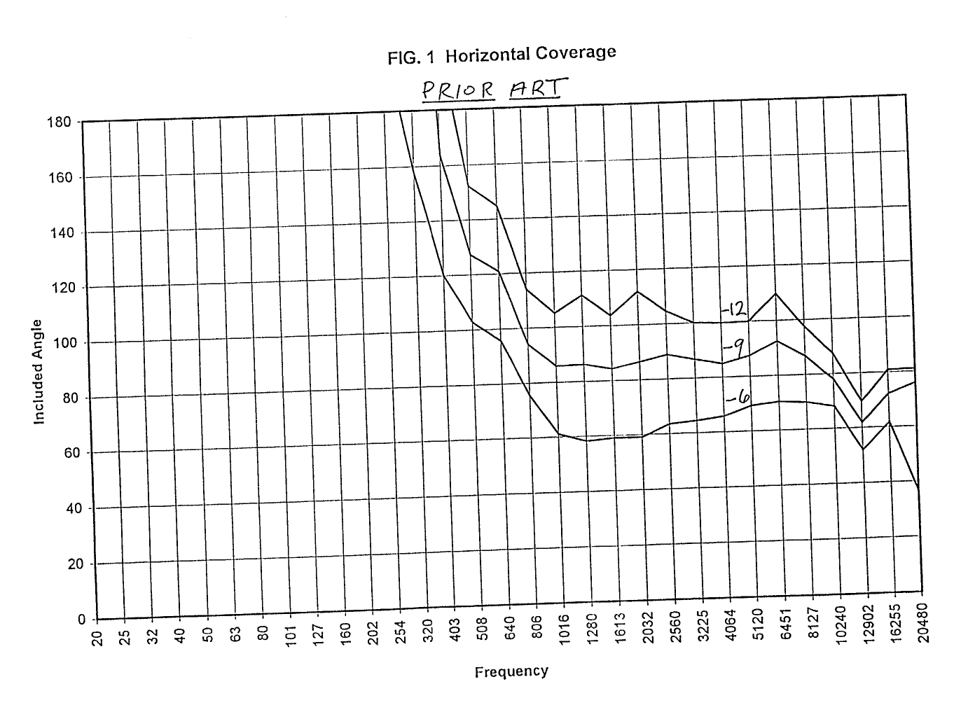

One method of determining how close a horn is approaching a sound wedge is to observe the coverage pattern of a horn at not only the −6 dB downpoint, but at the −9 and −12 downpoints as well. FIG. 1 shows the coverage pattern of a conventional horn having a mouth area of 256 sq. in. at the −6, −9 and −12 dB down angles.

Another way to attempt to simulate a perfect sound wedge provided by this invention is to utilize sound absorption material. Sound absorption material can be sculpted and arranged in close proximity with or about a horn to itself serve as a horn to provide an improved coverage pattern. However, with such a device, the directivity gain in SPL is compromised because the sound energy is being absorbed by the material rather than being focused. While the directivity index of the driver would still be valid in describing how directive the device is, its SPL would not increase as the coverage pattern decreases. Nonetheless, sound absorption has been found to improve the shape of the energy pattern and, hence, sound coverage. Indeed, utilizing sound absorbing material is effective with a horn component of any coverage pattern. Consequently, most public venues of modern design, particularly auditoriums and movie theaters, employ sound absorbing or “dampening” materials to improve sound quality and intelligibility.

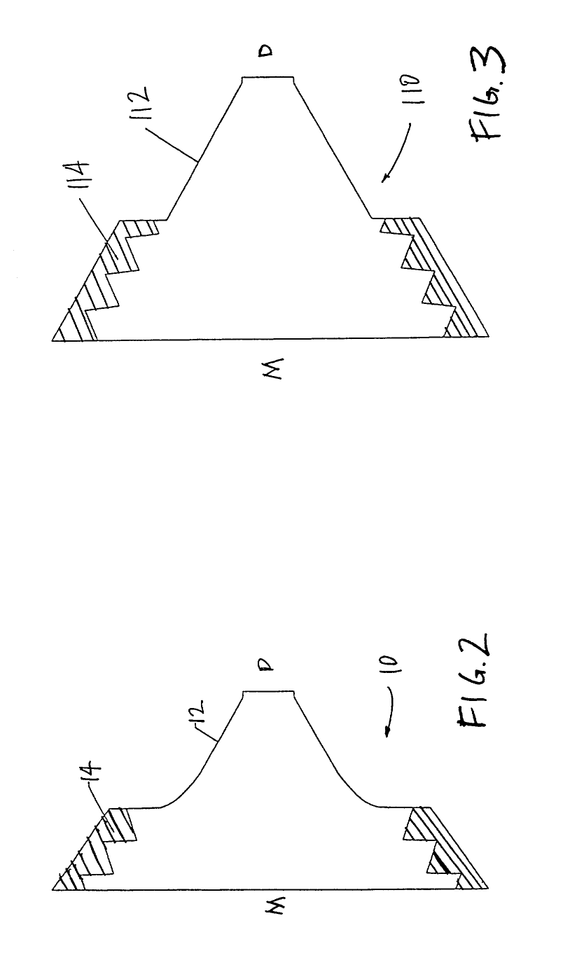

As shown in FIG. 2 in cross section, one preferred embodiment of this invention comprises an acoustic horn assembly 10 including a horn component 12 and sound absorption material 14 arranged just after or behind the horn component 12 adjacent to or in close proximity with its mouth or throat end “M.” The horn component 12 serves to preserve the SPL gain provided by horns, while the sound absorption material 14 decreases the energy beyond the first −6 dB down angle. The horn component 12 shown in FIG. 2 is a horn sold under the trademark TRACTRIX by Klipsch, LLC, Indianapolis, Ind., with a 60-degree coverage pattern. The sound absorbing material is secured to the horn by conventional methods known in the field, such as but not limited to pressure adhesives.

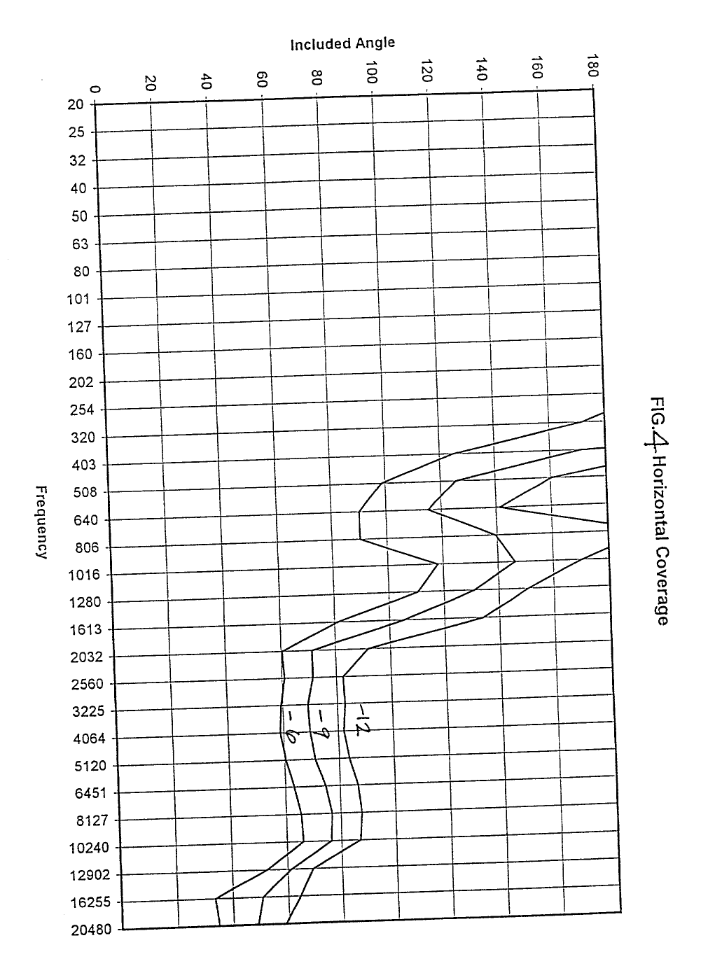

In FIG. 3, an alternative preferred horn assembly 110 is depicted including a horn component 112 and sound absorbing material 114 disposed adjacent the throat or mouth end “M” of the horn component 112. The horn component 112 shown in FIG. 3 is a truncated horn with a lower cutoff than the horn 12 of FIG. 2, and has a 60-degree coverage pattern. While the horn components 12 and 112 are 60-degree coverage horns, this invention is effective with horns of any coverage patterns, including for example 80-degree and 90-degree horns.

Testing has confirmed the improved coverage pattern produced by the horn assembly of this invention. The −6, −9 and −12 dB coverage pattern of a horn assembly provided by the invention, wherein the mouth area of the device is 256 sq. in., is shown in FIG. 4. Comparing the coverage patterns produced by a conventional horn (FIG. 1) and the horn assembly of this invention, e.g., reference numeral 10 in FIG. 2, wherein the horn components have equal mouth areas, confirms the improved sound coverage provided by this invention. For example, in the case of the conventional horn in FIG. 1, that horn has a 60-degree coverage pattern ±10 degrees. The −9 dB curve is about 85 degrees ±5 degrees, while the −12 dB curve is about 105 degrees ±5 degrees. The horn 12 has control down to about 800 Hz. The horn assembly of this invention, on the other hand, the coverage pattern for which is shown in FIG. 4, has a coverage pattern of 60 degrees ±5 degrees. The −9 dB curve is about 70 degrees ±5 degrees, while the −12 dB curve is 85 degrees ±5 degrees. This horn assembly enjoys control down to about 2000 Hz. As the frequency of the sound energy wished to be directed decreases (e.g., the sound wavelength gets longer), the volume of the horn and the sound absorbing material must naturally increase accordingly. While there is diffraction of the sound waves between 800 and 2000 Hz, it is believed that such is due to the discontinuity of the two different surfaces, that is, the fiberglass of the horn and acoustic foam defining the preferred sound absorbing material. The invention does in fact indeed provide less energy beyond the first −6 dB down angle.

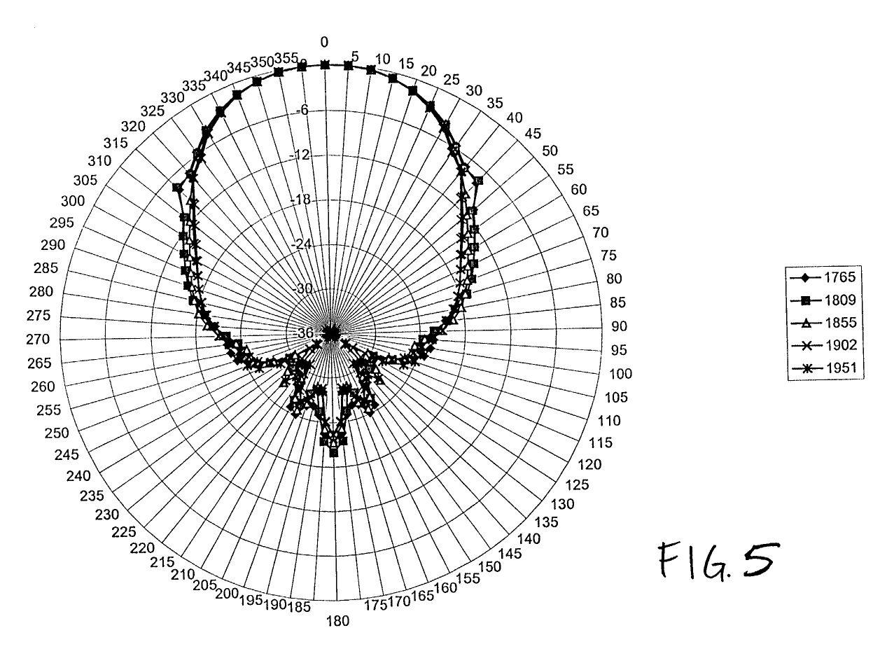

FIG. 5 is a polar plot of the sound energy produced by a horn assembly of this invention at certain frequencies, i.e., 1765 Hz, 1809 Hz, 1855 Hz, 1902 Hz and 1951 Hz, illustrating the frequency at which the sound-absorbing material begins to absorb the sound energy. In this polar plot, the 0-degree axis defines the “on” axis of the horn. At 1765 Hz and 35 degrees, the plot lines generally coincide, which suggests that sound absorption by the sound-absorbing material has not yet occurred. The plot lines tend to deviate at about 40-45 degrees, reflecting a difference of about 3 dB at 45 degrees. A 3-dB difference in sound levels is substantial, representing a 50% decrease in sound energy output. Beyond the −6 dB down angle the problems with conventional systems, such as reverberation, are decreased by this invention while sound intelligibility is increased.

Early attempts to reduce this invention to practice produced a horn assembly that offered less energy past the coverage pattern of the horn. While there are other features one may manipulate in an attempt to lower the coverage cutoff of the horn, in a currently preferred embodiment, the preferred means is sound absorbing material. The preferred sound absorbing material is acoustic foam, particularly open cell or reticulated foam. While acoustic foam is preferred, any material that absorbs sound, such as certain cloths, fiberglass, mineral wool and the like, is suitable.

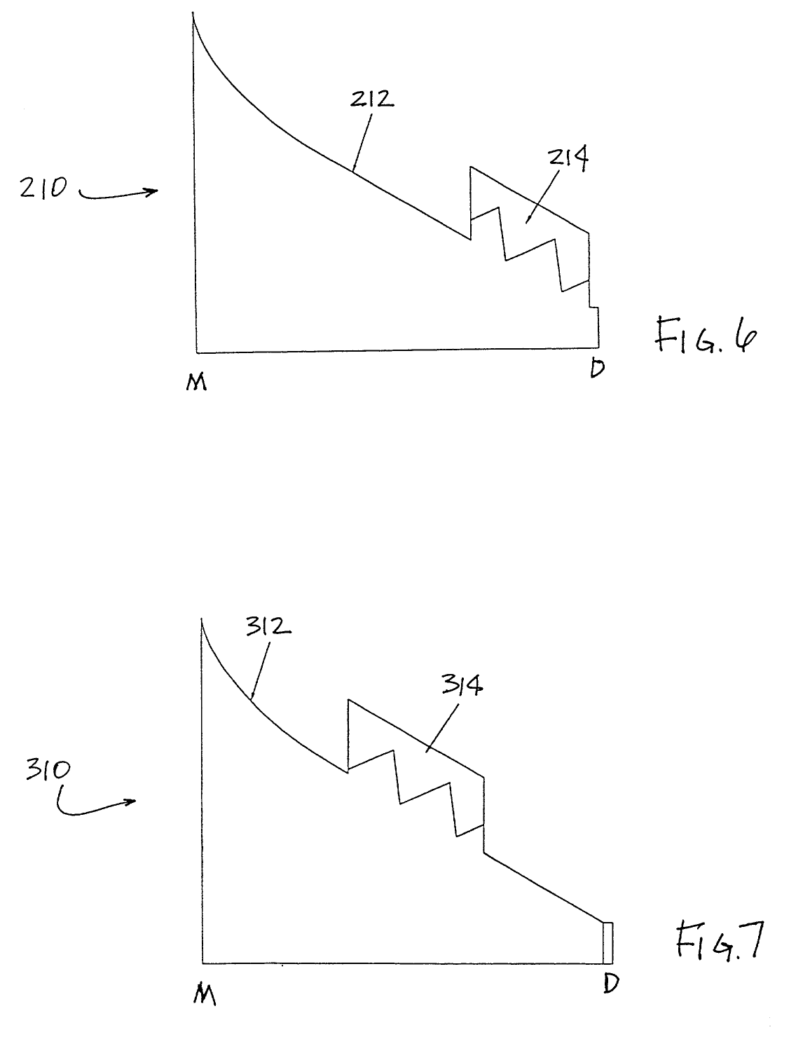

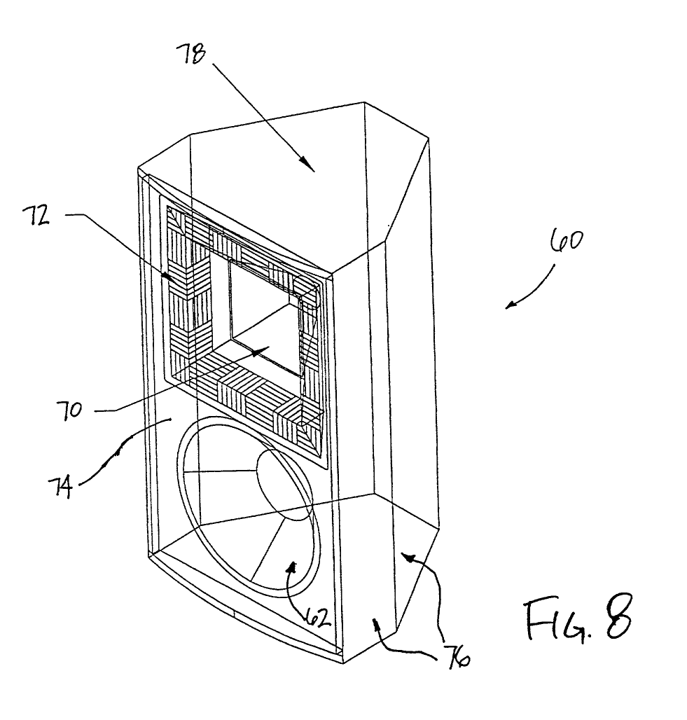

A second preferred embodiment of this invention shown in FIG. 6 includes a horn assembly 210 including a horn component 212 and a sound-absorbing material 214 arranged adjacent to the throat or driver end “D” of the horn assembly. In FIG. 7, a third preferred embodiment of this invention includes a horn assembly 310 including a horn component 312 and a sound-absorbing material 314 arranged in close proximity with horn component 312 at point somewhere between the driver end “D” or throat of the horn and the mouth “M” of the horn assembly.

FIG. 8 shows one manner in which a preferred embodiment of this invention may be utilized. The horn assembly of this invention may be housed in a loudspeaker 60 including one or more acoustic generators, such as one or more low frequency or woofer elements and one or more high frequency or tweeter elements. In use, multiple loudspeakers 60 may be employed in an array to provide improved sound coverage in large venues, such as movie theaters, auditoriums, arenas and the like. In the example loudspeaker shown in FIG. 8, a single speaker transducer 62 is shown defined by a woofer element, along with an acoustic horn 70 surrounded by sound absorbing material 72. Material 72 is secured within the enclosure in close proximity to the horn 70 by conventional means well known in the art. The speaker transducer and horn component are mounted and secured to a baffle board 74 of the loudspeaker cabinet 60. The speaker cabinet 60 has sidewalls 76, a rear wall (not shown), a top wall 78, and a bottom wall (again, not shown), which collectively, together with the baffle board 74, define a trapezoidal loudspeaker enclosure. Typically, various other electrical components are also mounted within the enclosure. When a loudspeaker of this invention is used in an array, the multiple acoustic sources more closely resemble or act as a single source to minimize interference between or among the sources, thereby resembling a single sound wedge and improving sound quality.

The horn component of this invention is preferably constructed of plastic or fiberglass material. While it's preferred that the baffle board and speaker enclosure provided by this invention be made of wood, other materials such as molded or fabricated plastic enclosures can be used without compromising the effective operation of this invention.

It should be appreciated that the sound absorbing material need not be disposed about the entire circumference or perimeter of the acoustic horn for the effective operation of this invention. For example, the sound absorbing material can be placed only partially about the perimeter or circumference of the horn or on one axis if absorption is only required in one plane.

Such novel combinations as shown in FIGS. 2, 3, 6 and 7 come very close to performing as a perfect sound wedge. In addition, to the extent to which one desires, the shape of the sound wave generated by the horn component can be varied by varying the length, thickness or type of sound absorbing material employed. For example, increasing the length, width or thickness of the sound absorbing material allows absorption of sound energy at lower frequencies.

Although the present invention has been described with a preferred embodiment, it is to be understood that variations and modifications may be made without departing from the scope of this invention as set forth in the following claims. Such variations and modification are considered to be within the purview and scope of the appended claims.

I claim:

1. An acoustic horn assembly, comprising:
an acoustic horn for generating a sound pressure level (SPL) at a given frequency, said horn having a mouth end and a driver end; and
sound absorbing material disposed in close proximity to said acoustic horn, said sound absorbing material assisting said acoustic horn in placing the optimal sound pressure level (SPL) in a desired location, thereby providing an improved sound coverage field.

2. The acoustic horn assembly of claim 1 wherein said sound absorbing material is disposed adjacent to the mouth end of said horn.

3. The acoustic horn assembly of claim 2 wherein said sound absorbing material is disposed about the entire circumference or perimeter of said horn adjacent to its mouth end.

4. The acoustic horn assembly of claim 2 wherein said sound absorbing material is disposed partially about the circumference of said horn adjacent to its mouth end.

5. The acoustic horn assembly of claim 1 wherein the horn preserves the sound pressure level (SPL) gain, and wherein the sound absorbing material decreases the sound pressure level (SPL) beyond the first −6 dB down angle.

6. The acoustic horn assembly of claim 1 wherein said sound absorbing material is disposed adjacent to the driver end of said horn.

7. The acoustic horn assembly loudspeaker of claim 1 wherein sound absorbing material is disposed between the driver end and the mouth end of said horn.

8. The acoustic horn assembly of claim 1 wherein said acoustic horn is constructed of plastic material.

9. The acoustic horn assembly of claim 1 wherein said acoustic horn is constructed of fiberglass material.

10. The acoustic horn assembly of claim 1 wherein said acoustic horn is constructed of wood.

11. A loudspeaker enclosure, comprising:
an acoustic horn for generating a sound pressure level (SPL) at a given frequency, said horn having a mouth end and a driver end;
sound absorbing material disposed in close proximity to said acoustic horn; and
a cabinet enclosure having a top wall, a bottom wall, two opposing sidewalls, a back wall, and a front wall, said front wall being provided with at least one opening therein for receiving said acoustic horn,
said sound absorbing material aiding said acoustic horn in placing the optimal sound pressure level (SPL) in a desired location, whereby an improved sound coverage field is provided.

12. The loudspeaker enclosure of claim 11 wherein said sound absorbing material is arranged adjacent to the mouth end of said horn.

13. The loudspeaker enclosure of claim 12 wherein said sound absorbing material is arranged about the entire circumference or perimeter of the mouth end of said horn.

14. The acoustic horn assembly of claim 12 wherein said sound absorbing material is dispatched partially about the circumference or perimeter of said horn adjacent to its mouth end.

15. The loudspeaker enclosure of claim 11 wherein said sound absorbing material is arranged closely adjacent to the driver end of said horn.

16. The loudspeaker enclosure of claim 15 wherein said sound absorbing material is arranged about the entire circumference of said horn.

17. The acoustic horn assembly of claim 15 wherein said sound absorbing material is arranged partially about the circumference of said horn adjacent to its mouth end.

18. The loudspeaker enclosure of claim 11 wherein said sound absorbing material is arranged about the horn between the mouth end and the driver end thereof.

19. The loudspeaker enclosure of claim 18 wherein said sound absorbing material is arranged about the entire circumference or perimeter of said horn.

20. The acoustic horn assembly of claim 18 wherein said sound absorbing material is disposed partially about the circumference or perimeter of said horn adjacent to its mouth end.

21. The loudspeaker enclosure of claim 11 wherein said horn preserves the sound pressure level (SPL) gain, and wherein the sound absorbing material decreases the sound pressure level (SPL) beyond the first −6 dB down angle.

22. The loudspeaker enclosure of claim 11 further comprising one or more acoustic generators in addition to said horn.

23. A method of constructing an acoustic horn assembly, comprising the steps of:
forming an acoustic horn having a mouth, a throat, and a generally truncated conical or pyramidal body with the larger cross surface area of the body defining the mouth thereof; and
securing sound absorbing material about the circumference or perimeter of said acoustic horn to enable the sound pressure level (SPL) generated by said horn to be more accurately directed.

24. The method of claim 23 wherein said securing step is carried out by securing said sound absorbing material in close proximity to the mouth of said horn.

25. The method of claim 23 wherein said securing step is carried out by securing said sound absorbing material in close proximity to the throat of said horn.

26. The method of claim 23 wherein said securing step is carried out by securing said sound absorbing material between the mouth and the throat of said horn.

27. The acoustic horn assembly of claim 1 wherein said sound absorbing material is defined by open cell or reticulated foam.

28. The loudspeaker enclosure of claim 11 wherein said sound absorbing material is defined by open cell or reticulated foam.

29. The method of claim 23 wherein said sound absorbing material is defined by open cell or reticulated foam.

30. An array of acoustic horn assemblies, each of said array comprising:
an acoustic horn for generating a sound pressure level (SPL) at a given frequency, said horn having a mouth end and a driver end; and
sound absorbing material disposed in close proximity to said acoustic horn, said sound absorbing material assisting said acoustic horn in placing the optimal sound pressure level (SPL) in a desired location, thereby providing an improved sound coverage field, the sound pressure level (SPL) generated by each acoustic horn being directed to a localized and separate coverage area to minimize interference between two adjacent sound pressure levels and improve the overall sound coverage generated by the array.

31. The array of acoustic horn assemblies of claim 30 wherein said sound absorbing material is disposed adjacent to the mouth end of the horn of each said acoustic horn assembly.

32. The array of acoustic horn assemblies of claim 30 wherein said sound absorbing material is disposed adjacent to the driver end of the horn of each said acoustic horn assembly.

33. The array of acoustic horn assemblies of claim 30 wherein said sound absorbing material is disposed between the driver end and the mouth end of each said acoustic horn assembly.

34. A method of providing improved loudspeaker sound coverage over large areas, comprising the steps of:
providing two or more acoustic horn assemblies for generating a sound pressure level (SPL) at a given frequency, each said acoustic horn assembly including a horn having a mouth end, a driver end and sound absorbing material disposed in close proximity to said acoustic horn, the sound absorbing material assisting the acoustic horn in placing the optimal sound pressure level (SPL) in a desired location; and
directing the sound pressure level (SPL) of each loudspeaker at a desired location so as to minimize interference between adjacent sound pressure levels such that the sound coverage over the entire large area is improved.
